(19) United States
(12) Patent Application Publication
(10) Pub. No.: US 2019/0335369 A1
(43) Pub. Date: Oct. 31, 2019

(54) METHOD FOR NETWORK ENTITY HANDOVER, TERMINAL AND NETWORK ENTITY DEVICE

(71) Applicant: CHINA ACADEMY OF TELECOMMUNICATIONS TECHNOLOGY, Beijing (CN)

(72) Inventors: Dajun ZHANG, Beijing (CN); Fangli XU, Beijing (CN)

(21) Appl. No.: 16/476,056

(22) PCT Filed: Feb. 12, 2018
(86) PCT No.: PCT/CN2018/076497

§ 371 Date: Jul. 3, 2019

(30) Foreign Application Priority Data
Jan. 6, 2017 (CN) 201710012121.1

(51) Int. Cl. H04W 36/00; H04W 36/08; H04W 36/18; H04W 80/08; H04W 28/06; H04W 76/27; H04W 74/08

(52) U.S. Cl. CPC H04W 36/0072; H04W 36/08; H04W 36/18; H04W 74/0833; H04W 28/06; H04W 76/27; H04W 80/08

(57) ABSTRACT

A method for network entity handover, a terminal, and a network entity device are disclosed by the present disclosure. The method includes: receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and when the new configuration parameter takes effect, not performing reset and/or reestablishment of bottom layer transmission, and transmitting an anchor change confirmation message to the second network entity.

### CROSS-REFERENCE TO RELATED APPLICATIONS

The present application claims a priority to Chinese Patent Application No. 201710012121.1 filed in China on Jan. 6, 2017, the entire disclosure of which is incorporated herein by reference.

### FIELD OF THE INVENTION

The present disclosure relates to the technical field of communications, and in particular, to a method for network entity handover, a terminal and a network entity device.

### BACKGROUND OF THE INVENTION

After an UE (User Equipment) moves to a position where signals of two network entities (eNB, evolved Node B) cover and overlap with each other, the network will trigger a mobility event, as shown in FIG. 1, which is an ordinary dual-connection mobile scenario, wherein the UE maintain wireless connection with both a first eNB and a second eNB.

FIG. 2 shows a conventional handover process, including:

0. Area restrictions are set between source eNB and target eNB, as well as between MME (Mobility Management Entity) and SG (Serving gateway).

1. The source eNB transmits measurement control to the terminal, the terminal transmits a data packet with the source eNB, the data packet is transmitted between the source eNB and the serving gateway, and the source eNB performs uplink configuration for the terminal.

2. The terminal transmits a measurement report to the source eNB;

3. The source eNB decides to handover;

4. The source eNB transmits a handover request to the target eNB;

5. The target eNB agrees to handover and accepts the handover request;

6. The target eNB feeds back a handover request response to the source eNB, and the source eNB performs downlink configuration for the terminal;

7. The source eNB transmits RRC (Radio Resource Control) configuration, reconfiguration and the like, and mobility control information to the terminal. After receiving the configuration information, the terminal leaves the old cell and synchronizes to a new cell.

8. The source eNB transmits the data packet to the target eNB, transmits the sequence number status of the data packet to the target eNB, and transmits the data to the target eNB, and the data packet is buffered by the target eNB;

9. The terminal synchronizes with the target eNB;

10. The target eNB transmits uplink configuration to the terminal;

11. The terminal transmits the RRC configuration and reconfiguration to the target eNB, and after completion, the data packet is transmitted with the target eNB, and the data packet is transmitted by the target eNB to the serving gateway;

12. The target eNB transmits a path switch request to the MME;

13. After receiving the path switch request, the MME transmits a modify bearer request to the serving gateway.

14. After switching the downlink path, the serving gateway transmits an end Marker to the source eNB, and after receiving the feedback from the source eNB, the serving gateway performs data packet transmission with the target ENB.

15. The serving gateway transmits a modify bearer response to the MME.

16. The MME transmits a path switch response to the target eNB;

17. The target eNB transmits a release context message to the source eNB; and

18. The source eNB releases the corresponding resource.

In the above process, data transmission between the terminal and the original eNB side is interrupted firstly, and then the service transmission is continued after the target eNB is accessed, thus causing a great data interruption.

To this end, similar to the traditional DC (data interruption) operation, such as adding the target node as the SeNB to the source side communication, the Split DRB (split data radio bearer) mode is adopted, as shown in FIG. 3:

1. The source eNB transmits a request to the target eNB to allow the target eNB to join the source side network (carrying configuration information of the serving gateway);

2. The target eNB and the source eNB transmit a response (carrying configuration information of the serving gateway) to join the source side network;

3. The source eNB transmits an RRC connection reconfiguration message to the UE;

4. The UE transmits an RRC connection reconfiguration completion message to the source eNB.

5. The source eNB transmits a configuration completion message to the target eNB; and

6. The target eNB performs a random access procedure with the UE.

In the above mobility event, there is no core network signaling, that is, the signaling anchor does not change, and the mobility event belongs to the mobility event on the RAN (Radio Access Network) side, wherein the data is not interrupted.

A multi-connection UE can be simultaneously connected with more than two network entities (each network entity containing at least one independent MAC entity);

wherein there is only one master network entity (a network entity where the PDCP (Packet Data Convergence Protocol) functional entity (a logical entity including functions such as security/compression/ordering) of signaling bearer and/or data bearer is located, and a termination point connected to the core network by signaling and/or data); and

there are one or more slave network entities (without PDCP functional entities of signaling bearer and a terminal point connected to the core network by signaling, mainly participating in data transmission, at least having functional entities (segmentation/serial connection/multiplexing/scheduling/encoding/modulation, etc.) similar to RLC (Radio Link Layer Control Protocol), MAC, a physical layer and the like for each bearer.

After the occurrence of the mobility event shown above in FIG. 1, the UE will be in a multi-connection state. According to the related art implementation and the multi-connection operation described above, it is possible that UE does not cause a service interruption in the mobility event, but for the multi-connection UE, a state in which the anchor does not change cannot be always maintained, which will lead to many adverse results to the system, such as an excessively long transmission path, excessively concentrated processing loads, etc., thereby degrading the performance of the entire system. With the continuous evolution of the network, inter-node mobility events under the traditional network architecture cannot meet the higher demands posed on mobility performance. For example, keeping data interruption at the minimal (even Oms) during handover has become a basic requirement for next-generation network development.

### SUMMARY OF THE INVENTION

Embodiments of the present disclosure provide a method for network entity handover, a terminal, and a network entity device, which can ensure seamless transfer of service data, thereby alleviating adverse effects on the system.

To address the above technical problem, embodiments of the present disclosure provide the following technical solutions:

A method for network entity handover, including:

receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and

when the new configuration parameter takes effect, not performing reset and/or reestablishment of bottom layer transmission, and transmitting an anchor change confirmation message to the second network entity.

Optionally, after the anchor change confirmation message is transmitted to the second network entity, the method further includes:

after the second network entity switches a path from the first network entity to the second network entity according to the anchor change confirmation message, performing data transmission with the second network entity.

Optionally, the step of performing data transmission with the second network entity includes:

transmitting, through a first configuration sublayer, a new data packet to be transmitted to the second network entity, to the second network entity; or

processing, through the first configuration sublayer, the new data packet received from the second network entity.

Optionally, the step of transmitting through the first configuration sublayer the new data packet to be transmitted to the second network entity to the second network entity includes:

adding a new sequence number to a packet header of the data packet to be transmitted to the second network entity, and sequentially compressing, encrypting, and increasing the packet header of the data packet to obtain the new data packet; and

transmitting the new data packet to the second network entity through a bottom layer according to routing information.

Optionally, the packet header of the data packet carries indication information of new data transmitted to the second network entity and included in the data packet.

Optionally, the step of processing through the first configuration sublayer the new data packet received from the second network entity includes:

removing a packet header from the new data packet received from the second network entity to obtain a processed data packet; and

sequentially decrypting, re-ordering, and decompressing the data packet, and then transmitting the data packet to an in-order delivery and duplicate detection functional entity for processing.

Optionally, the step of sequentially decrypting, re-ordering, and decompressing the data packet, and then transmitting the data packet to the in-order delivery and duplicate detection functional entity for processing includes:

decrypting the data packet and transmitting the data packet to a re-ordering entity, forwarding the re-ordered new data packet to a decompressing entity of the first configuration sublayer for decompression operation, according to header information, and then transmitting the data packet to the in-order delivery and duplicate detection functional entity for processing; or

decrypting the data packet, transmitting the data packet to a re-ordering entity and a decompressing entity for corresponding processing, and then transmitting the data packet to the in-order delivery and duplicate detection functional entity for processing.

Optionally, the new data packet includes: a new signaling data packet and/or a new service data packet.

Optionally, after the second network entity switches a path from the first network entity to the second network entity according to the anchor change confirmation message, the method further includes:

performing transmission of service data packet with the first network entity.

Optionally, the step of performing transmission of the service data packet with the first network entity includes:

transmitting, through a second configuration sublayer, the service data packet to be transmitted to the first network entity to the bottom layer, and transmitting the service data packet to the first network entity; or

transmitting, through the bottom layer, the service data packet received from the first network entity to the second configuration sublayer for processing.

Optionally, the step of transmitting through the second configuration sublayer the service data packet to be transmitted to the first network entity to the bottom layer, and transmitting the service data packet to the first network entity includes:

after the service data packet to be transmitted to the first network entity is sequentially compressed and encrypted, transmitting the service data packet to the first network entity through the bottom layer according to routing information.

Optionally, the step of transmitting through the bottom layer the service data packet received from the first network entity to the second configuration sublayer for processing includes:

sequentially decrypting, re-ordering, and decompressing the service data packet received from the first network entity through the bottom layer, and then transmitting the data packet to an in-order delivery and duplicate detection functional entity for processing.

Optionally, the handover method further includes:

when the terminal has received correctly the data packet from the first network entity before a sequence number of the data packet of the second network entity, and the terminal has received a confirmation message that the first network entity has received uplink data packet transmitted by all of the terminals before the sequence number, triggering a release operation of the second configuration sublayer.

Optionally, a triggering condition for the new configuration parameter to take effect includes:

when the terminal receives the new configuration parameter, the new configuration parameter immediately takes effect, and the terminal transmits triggering information to notify the second network entity, to enable the second network entity to perform an effectiveness triggering operation on the new configuration parameter; or

when the terminal receives the indication information transmitted by the second network entity through the bottom layer, the terminal performs an effectiveness triggering operation on the new configuration parameter, and when the second network entity transmits the indication information, the second network entity performs an effectiveness triggering operation on the new configuration parameter; or

after the terminal receives the new configuration parameter, the terminal triggers an effectiveness operation on the new configuration parameter at a preset time point, and the second network entity performs an effectiveness triggering operation on the new configuration parameter at the preset time point.

Optionally, the triggering information carries a sequence number of a new data packet transmitted to the second network entity; and

the indication information carries the sequence number of the new data packet transmitted by the second network entity to the User Equipment (UE).

An embodiment of the present disclosure further provides a method for network entity handover, including:

transmitting, by a first network entity that is connected to a terminal to a second network entity that is connected to the terminal, indication information of an anchor change operation of changing an anchor from the first network entity to the second network entity;

receiving, by the first network entity, a new configuration parameter returned by the second network entity according to the indication information; and

transmitting, by the first network entity, the new configuration parameter to the terminal, the new configuration parameter being used to enable the terminal to perform a new configuration according to the configuration parameter, and to switch an anchor to the second network entity after the new configuration is completed.

Optionally, the second network entity is a network entity selected, by the first network entity, from a plurality of network entity that are connected to the terminal, according to a radio channel condition of the terminal, a load condition of the network entity, a path delay between the terminal and the network entity, and/or a radio resource management policy.

Optionally, the indication information at least includes new configuration information based on the second network entity, and the new configuration information includes security context information based on the second network entity.

Optionally, the indication information further includes: an effectiveness time point of the new configuration information, a radio configuration parameter of a signaling bearer based on the first network entity, and/or a Packet Data Convergence Protocol (PDCP) configuration parameter of a data bearer based on the first network entity.

Optionally, the new configuration parameter includes: a new encryption algorithm based on the second network entity, a radio configuration parameter of a signaling bearer, a PDCP parameter of a data bearer and/or a radio parameter of a bottom layer transmission used to update the data bearer from the first network entity to the second network entity.

Optionally, the step of transmitting by the first network entity the new configuration parameter to the terminal includes:

transmitting, by the first network entity, the new configuration parameter to the terminal through a Radio Resource Control (RRC) message.

Optionally, the handover method further includes:

when the first network entity receives a sequence number of a new data packet notified by the second network entity, the first network entity determines that the service data packet transmitted by the first network entity to the terminal before the sequence number has been correctly received by the terminal, and that the service data packet transmitted by the terminal has been correctly received, and the first network entity is triggered to release its configuration sublayer, and a connection relationship between the configuration sublayer and a bottom layer of the first network entity.

An embodiment of the present disclosure further provides a method for network entity handover, including:

receiving, by a second network entity that is connected to a terminal, indication information of an anchor change operation of changing an anchor from a first network entity to the second network entity, and the indication information being transmitted by the first network entity that is connected to the terminal; and

returning a new configuration parameter to the first network entity according to the indication information, and transmitting the new configuration parameter to the terminal by the first network entity, the new configuration parameter being used to enable the terminal to perform a new configuration according to the new configuration parameter, and to switch an anchor to the second network entity after the new configuration is completed.

Optionally, the handover method further includes:

receiving, by the second network entity, an anchor change confirmation message returned by the terminal after the terminal completes the configuration according to the new configuration parameter; and

switching a path from the first network entity to the second network entity according to the anchor change confirmation message or according to the new configuration parameter that has taken effect.

Optionally, the step of switching a path from the first network entity to the second network entity according to the anchor change confirmation message or according to the new configuration parameter that has taken effect includes:

transmitting a path switch request message to a session gateway controller according to the anchor change confirmation message or according to the new configuration parameter that has taken effect; and

receiving a switch completion response message returned by the session gateway controller, and the switch completion response message indicating that a path has been switched from the first network entity to the second network entity.

Optionally, the handover method further includes:

performing data transmission with the terminal.

Optionally, the step of performing data transmission with the terminal includes:

transmitting, through a configuration sublayer of the second network entity, a new data packet to be transmitted to the terminal to the terminal; or

processing, through the configuration sublayer, the new data packet received from the terminal.

Optionally, the step of transmitting through the configuration sublayer of the second network entity the new data packet to be transmitted to the terminal to the terminal includes:

adding a new sequence number to a packet header of the data packet transmitted to the terminal, sequentially compressing, encrypting, and increasing the packet header of the data packet to obtain new data packet, and transmitting the new data packet to the terminal through a bottom layer according to routing information.

Optionally, the packet header of the data packet includes indication information of new data transmitted to the terminal and included in the data packet.

Optionally, the step of processing through the configuration sublayer the new data packet received from the terminal includes:

removing a packet header from the new data packet received from the terminal to obtain a processed data packet; and

sequentially decrypting, re-ordering, and decompressing the data packet, and then transmitting the data packet to an in-order delivery and duplicate detection functional entity for processing.

Optionally, the new data packet includes: a new signaling data packet and/or a new service data packet.

Optionally, a triggering condition for the new configuration parameter to take effect includes:

when triggering information transmitted by the terminal is received, an effectiveness triggering operation is performed on the new configuration parameter, wherein the triggering message is triggering information transmitted by the terminal after the new configuration parameter takes effect immediately after the terminal receives the new configuration parameter; or

before transmitting the indication information to the terminal through a bottom layer, an effectiveness triggering operation is performed on the new configuration parameter, wherein the indication information is used to enable the terminal to perform an effectiveness triggering operation on the new configuration parameter; or

an effectiveness operation is triggered on the new configuration parameter at a preset time point, and the terminal performs an effectiveness triggering operation on the new configuration parameter at the preset time point.

Optionally, after the new configuration parameter takes effect, the second network entity does not perform reset and/or reestablishment of a bottom layer transmission.

An embodiment of the present disclosure further provides a terminal, including:

a receiver configured to: receive a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and

a transmitter configured to: when the new configuration parameter takes effect, not perform reset and/or reestablishment of bottom layer transmission, and transmit an anchor change confirmation message to the second network entity.

An embodiment of the present disclosure further provides a network entity device, including:

a transmitter configured to: transmit indication information of an anchor change operation of changing an anchor from a first network entity to a second network entity, to the second network entity that is connected to a terminal; and

a receiver configured to: receive new configuration parameter returned by the second network entity according to the indication information;

wherein the transmitter is further configured to transmit the new configuration parameter to the terminal, the new configuration parameter being used to enable the terminal to perform a new configuration according to the configuration parameter, and to switch an anchor to the second network entity after the new configuration is completed.

An embodiment of the present disclosure further provides a network entity device, including:

a receiver configured to: receive indication information of an anchor change operation of changing an anchor from a first network entity to a second network entity, and the indication information being transmitted by the first network entity that is connected to the terminal; and

a transmitter configured to: return new configuration parameter to the first network entity according to the indication information, and transmit the new configuration parameter to the terminal by the first network entity, the new configuration parameter being used to enable the terminal to perform a new configuration according to the new configuration parameter, and to switch an anchor to the second network entity after the new configuration is completed.

In the foregoing embodiments of the present disclosure, for a multi-connection UE, the master network entity (the first network entity) may select a certain one of the slave network entities (the second network entity) as the new anchor, thus triggering an anchor (referring to the master network entity) change operation; as such, a seamless transfer of service data can be ensured.

### BRIEF DESCRIPTION OF THE DRAWINGS

FIG. 1 is a schematic diagram of a network scenario of a multi-connection terminal in the related art;

FIG. 2 is a schematic flowchart of path switching of the terminal between different network entities in the related art;

FIG. 3 is another schematic flowchart of path switching of the terminal between different network entities in the related art;

FIG. 4 is a schematic flowchart of a method for network entity handover performed by a terminal side according to some embodiments of the present disclosure;

FIG. 5 is a schematic diagram of a process of processing downlink data by a PDCP entity at a terminal side according to some embodiments of the present disclosure;

FIG. 6 is a schematic diagram of a process of processing uplink data by a PDCP entity at a terminal side according to some embodiments of the present disclosure;

FIG. 7 is a schematic flowchart of a method for network entity handover at a first network entity side according to some embodiments of the present disclosure;

FIG. 8 is a schematic flowchart of a method for network entity handover at a second network entity side according to some embodiments of the present disclosure;

FIG. 9 is a schematic flowchart of implementation example 1 of the present disclosure; and

FIG. 10 is a schematic flowchart of implementation example 2 of the present disclosure.

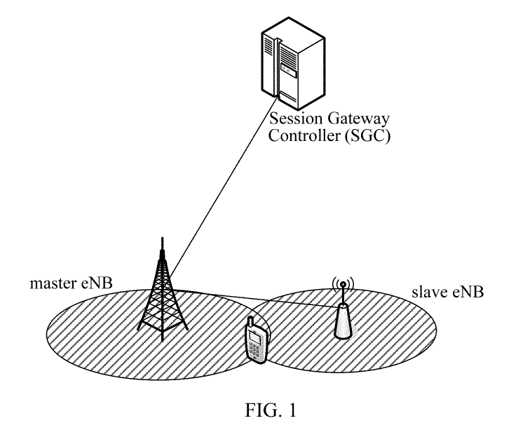

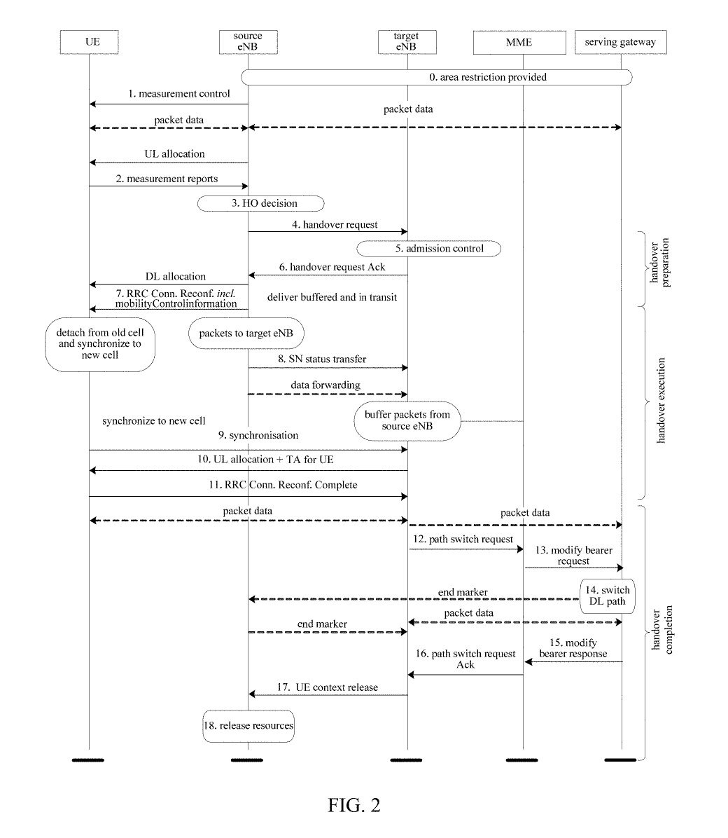

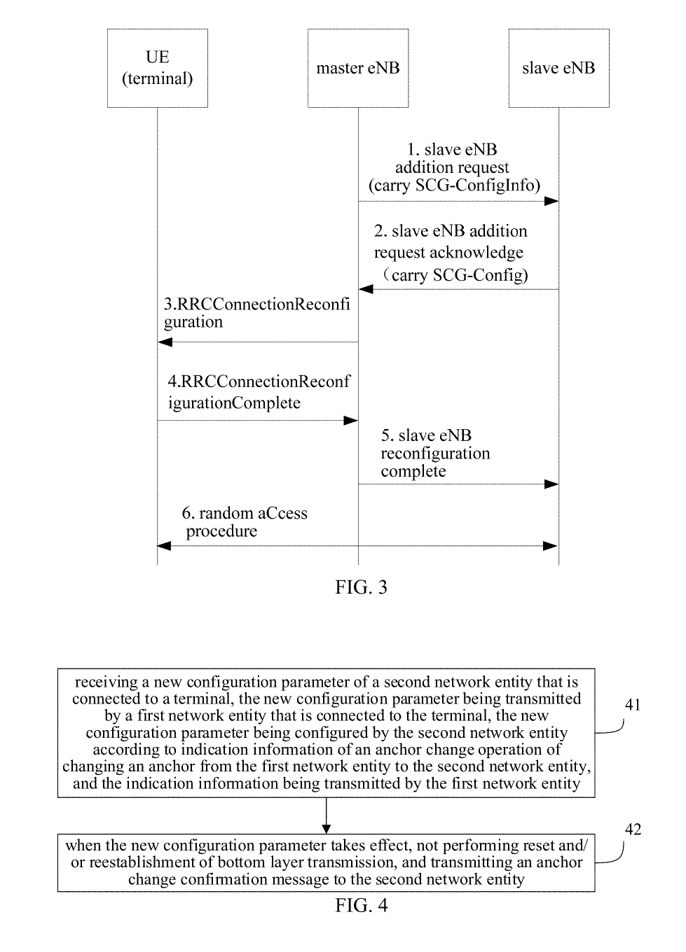

### DETAILED DESCRIPTION OF THE EMBODIMENT(S) OF THE INVENTION

Exemplary embodiments of the present disclosure will be described in greater detail below with reference to the accompanying drawings. While exemplary embodiments of the present disclosure are illustrated in the drawings, it should be understood that the present disclosure can be implemented in various ways and should not be limited by the embodiments set forth herein. Rather, these embodiments are provided so that the present disclosure can be more thoroughly understood and that the scope of the present disclosure can be fully conveyed to those skilled in the art.

As shown in FIG. 4, some embodiments of the present disclosure provide a method for network entity handover, including:

step 41: receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and

step 42: when the new configuration parameter takes effect, not performing reset and/or reestablishment of bottom layer transmission, and transmitting an anchor change confirmation message to the second network entity.

In this embodiment, a triggering condition for the new configuration parameter of the terminal to take effect includes:

1) when the terminal receives the new configuration parameter, the new configuration parameter immediately takes effect, and the terminal transmits triggering information to notify the second network entity, to enable the second network entity to perform an effectiveness triggering operation on the new configuration parameter; wherein the triggering information carries a sequence number of a new data packet transmitted to the second network entity; or

2) when the terminal receives the indication information transmitted by the second network entity through the bottom layer, the terminal performs an effectiveness triggering operation on the new configuration parameter, and when the second network entity transmits the indication information, the second network entity performs an effectiveness triggering operation on the new configuration parameter; wherein the indication information carries a sequence number of a new data packet transmitted to the UE by the second network entity; or

3) after the terminal receives the new configuration parameter, the terminal triggers an effectiveness operation on the new configuration parameter at a preset time point, and the second network entity performs an effectiveness triggering operation on the new configuration parameter at the preset time point.

In the above embodiment of the present disclosure, for a multi-connection UE, the master network entity (the first network entity) may select a certain one of the slave network entities (the second network entity) as the new anchor, thus triggering an anchor (referring to the master network entity) change operation; as such, a seamless transfer of service data can be ensured, thereby alleviating adverse effects on the system.

Some embodiments of the present disclosure provide a method for network entity handover, including:

step 41: receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and

step 42: when the new configuration parameter takes effect, not performing reset and/or reestablishment of bottom layer transmission, and transmitting an anchor change confirmation message to the second network entity; and

step 43: after the second network entity switches a path from the first network entity to the second network entity according to the anchor change confirmation message, performing data transmission with the second network entity.

Specifically, the step of performing data transmission with the second network entity includes:

step 431: in the uplink direction, transmitting, through a first configuration sublayer, a new data packet to be transmitted to the second network entity, to the second network entity; or

step 432: in the downlink direction, processing by the first configuration sublayer the new data packet received from the second network entity.

The first configuration sublayer may be a PDCP (packet data convergence protocol) first configuration sublayer, and the above step 431 may specifically include:

step 4311: adding a new sequence number to the packet header of the data packet transmitted to the second network entity, and sequentially compressing, encrypting, and increasing the packet header of the data packet to obtain new data packet; and

step 4312: transmitting the new data packet to the second network entity through a bottom layer according to routing information.

The packet header of the data packet carries indication information of new data transmitted to the second network entity and included in the data packet. The new data packet includes: a new signaling data packet and/or a new service data packet.

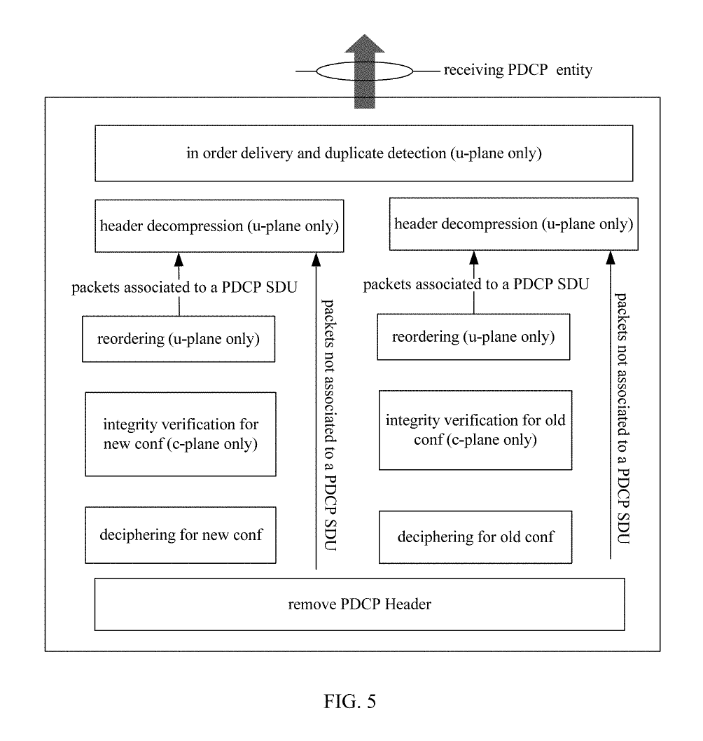

As shown in FIG. 5, after the UE triggers the effectiveness operation on the new configuration parameter, no reestablishment or reset operation is performed on the layer 2/physical layer, and there are two sets of PDCP sub-configurations for each DRB (data resource block) and/or SRB (signaling resource block).

The two sets of PDCP sub-configurations as a whole remain connected to the original two or more layers 2/physical layers.

In the uplink direction, all the RLC/MAC/PHY (Physical Layer) continue to maintain the original transmission activity; at the same time, the new PDCP SDU is assigned a new SN (Sequence Number) and is then delivered to the new configuration sublayer for sequentially compressing, encrypting, and increasing PDU (Protocol Data Unit) headers, wherein the header contains new data indication. Then, according to the routing information, the data is transmitted to an appropriate RLC/MAC/PHY connection for data transmission.

The above step 432 may specifically include:

step 4321: removing a packet header from the new data packet received from the second network entity to obtain processed data packet; and

step 4322: sequentially decrypting, re-ordering, and decompressing the data packet, and then transmitting it to in-order delivery and duplicate detection functional entities for processing; specifically:

decrypting the data packet and then transmitting it to a re-ordering entity (sharing the same one re-ordering entity with the second configuration sublayer), forwarding the re-ordered new data packet to a decompressing entity of the first configuration sublayer for decompression operation, according to header information, and then transmitting it to the in-order delivery and duplicate detection functional entities (sharing the same one re-ordering entity with the second configuration sublayer) for processing; or

decrypting the data packet, then transmitting it to a re-ordering entity (sharing the same one re-ordering entity with the second configuration sublayer) and a decompressing entity (sharing the same one decompressing entity with the second configuration sublayer) for corresponding processing, and finally transmitting it to the in-order delivery and duplicate detection functional entity (sharing the same one re-ordering entity with the second configuration sublayer) for processing.

The new data packet includes: a new signaling data packet and/or a new service data packet.

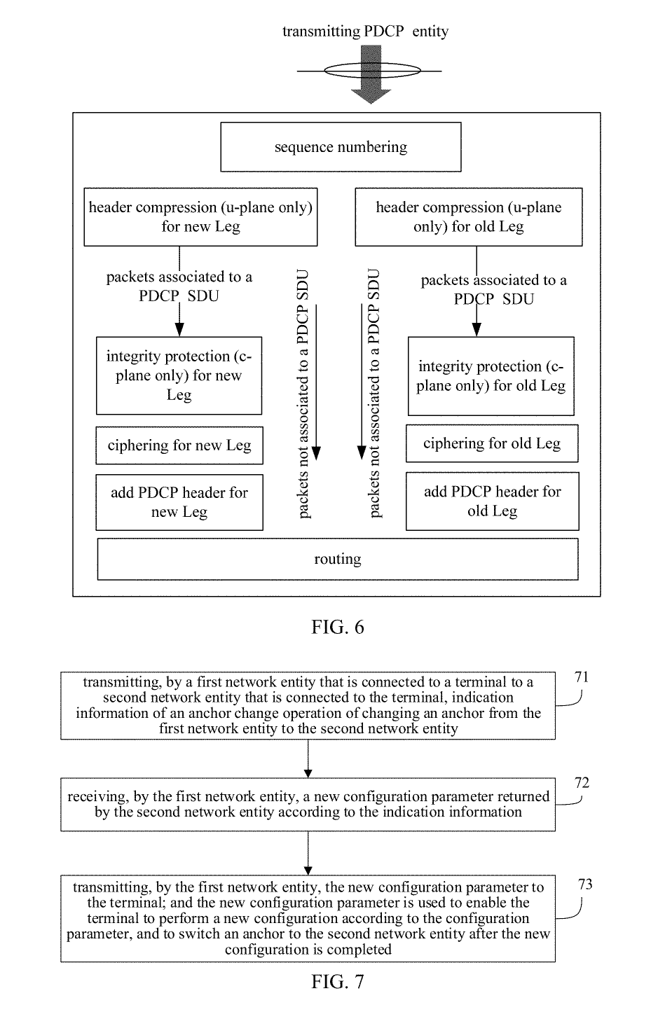

As shown in FIG. 6, after the UE triggers the effectiveness operation on the new configuration parameter, no reestablishment or reset operation is performed on the layer 2/physical layer, and there are two sets of PDCP sub-configurations for each DRB (data resource block) and/or SRB (signaling resource block).

The two sets of PDCP sub-configurations as a whole remain connected to the original two or more layers 2/physical layers.

In the downlink direction, the PDCP PDU (Protocol Data Unit) of any RLC (Radio Link Control) is received, and a header removing operation is performed. If the PDU header contains new data indication, then the PDU is delivered to the new configuration sublayer for sequentially decrypting, re-ordering and decompressing, before being transmitted to the in-order delivery and duplicate detection functional entity.

If the PDU header does not contain new data indication, then the PDU is delivered to the old configuration sublayer for similar sequential operations, also before being transmitted to the in-order delivery and duplicate detection functional entity.

In this embodiment, a triggering condition for the new configuration parameter of the terminal to take effect include:

1) when the terminal receives the new configuration parameter, the new configuration parameter immediately take effect, and the terminal transmits triggering information to notify the second network entity, to enable the second network entity to perform an effectiveness triggering operation on the new configuration parameter; wherein the triggering information carries a sequence number of new data packet transmitted to the second network entity; or

2) when the terminal receives the indication information transmitted by the second network entity through the bottom layer, an effectiveness triggering operation is performed on the new configuration parameter, and when the second network entity transmits the indication information, an effectiveness triggering operation is performed on the new configuration parameter; wherein the indication information carries a sequence number of new data packet transmitted to the UE by the second network entity; or

3) after the terminal receives the new configuration parameter, the terminal triggers an effectiveness operation on the new configuration parameter at a preset time point, and the second network entity performs an effectiveness triggering operation on the new configuration parameter at the preset time point.

In the present embodiment, for a multi-connection UE, the master network entity (the first network entity) may select a certain one of the slave network entities (the second network entity) as the new anchor, thus triggering an anchor (referring to the master network entity) change operation; a signaling transmission and/or data transmission is further realized for the second network entity (the new anchor) and the terminal, so that a seamless transfer of service data can be ensured, thereby alleviating adverse effects on the system.

Some embodiments of the present disclosure provide a method for network entity handover, including:

step 41: receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and

step 42: when the new configuration parameter takes effect, not performing reset and/or reestablishment of bottom layer transmission, and transmitting an anchor change confirmation message to the second network entity; and

step 43: after the second network entity switches the path from the first network entity to the second network entity according to the anchor change confirmation message, performing service data packet transmission with the first network entity.

In this embodiment, in step 43, the step of performing service data packet transmission with the first network entity includes:

in the uplink direction, transmitting, through a second configuration sublayer, a service data packet to be transmitted to the first network entity to the bottom layer, and to the first network entity; or

in the downlink direction, processing the service data packet received from the first network entity by transmitting it to the second configuration sublayer through the bottom layer.

The second configuration sublayer may be a PDCP (packet data convergence protocol) first configuration sublayer.

The specific processing procedure in the uplink direction includes:

sequentially compressing and encrypting the service data packet to be transmitted to the first network entity, and then transmitting the service data packet to the first network entity through the bottom layer according to routing information.

The specific processing procedure in the downlink direction includes:

sequentially decrypting, re-ordering and decompressing the service data packet received from the first network entity through the bottom layer, and then transmitting it to the in-order delivery and duplicate detection functional entity for processing.

A triggering condition for the new configuration parameter of the terminal to take effect include:

1) when the terminal receives the new configuration parameter, the new configuration parameter immediately take effect, and the terminal transmits triggering information is to notify the second network entity, to enable the second network entity to perform an effectiveness triggering operation on the new configuration parameter; wherein the triggering information carries a sequence number of new data packet transmitted to the second network entity; or

2) when the terminal receives the indication information transmitted by the second network entity through the bottom layer, an effectiveness triggering operation is performed on the new configuration parameter, and when the second network entity transmits the indication information, an effectiveness triggering operation is performed on the new configuration parameter; wherein the indication information carries a sequence number of new data packet transmitted to the UE by the second network entity; or

3) after the terminal receives the new configuration parameter, the terminal triggers an effectiveness operation on the new configuration parameter at a preset time point, and the second network entity performs an effectiveness triggering operation on the new configuration parameter at the preset time point.

In this embodiment, as the new slave network entity, the first network entity can perform service data packet transmission with the terminal.

Further, in this embodiment, if the terminal has received correctly the data packet from the first network entity before the sequence number of the data packet of the second network entity, and has received a confirmation message that the first network entity has received the uplink data packet transmitted by all the terminals before the sequence number, then a release operation of the second configuration sublayer is triggered. As such, the processing burden on the terminal can be lessened.

In this embodiment of the present disclosure, for a multi-connection UE, the master network entity (the first network entity) may select a certain one of the slave network entities (the second network entity) as the new anchor, thus triggering an anchor (referring to the master network entity) change operation; a signaling transmission and/or data service transmission is further realized for the second network entity (the new anchor) and the terminal, and the first network entity (the original anchor) can further server as the slave network entity, thus realizing data service transmission for the terminal and the first network entity. As such, a seamless transfer of service data can be ensured, thereby alleviating adverse effects on the system.

In the above embodiments of the present disclosure, the network side may, based on the radio channel condition of the UE, the load status, the path delay, or other RRM (Radio Resource Management) policies, select a certain one of the slave network entities as the new master network entity, thus triggering an anchor (referring to the master network entity) change operation; as such, a seamless transfer of service data can be ensured, thereby alleviating adverse effects on the system.

Specifically, at least one of the following two operations is performed, or the two operations are performed simultaneously:

i) transferring PDCP entities of all the bearers from the master network entity (the first network entity) to the target slave network entity (the second network entity), and performing the reestablishment operation; and

ii) changing the signaling termination point and/or data path from the terminal to the core network (from the master network entity to the target slave network entity); wherein in the related art, the signaling termination point from the terminal to the core network is the master network entity, wherein in the embodiments of the present disclosure, the signaling termination point from the terminal to the core network is the target slave network entity.

Once the new configuration parameter takes effect, the target becomes a new anchor (master network entity) from the network entity, while other network entities (including the original master network entity) become new slave entities.

For the anchor change operation, the network side reconfigures PDCP-related parameter of the signaling bearer and/or the data bearer at the target anchor, or may update other functional entity parameters, etc., and transmits these parameters to the UE through the RRC message of the master network entity.

On the UE side, once the new configuration parameter (including at least the new security context configuration and/or the new header compression configuration) are received, they take effect immediately. In the uplink direction, an indication is transmitted through the physical layer or the MAC layer or the RLC layer to inform the network side that the new configuration parameter has taken effect. Specifically, the indication may be only one piece of indication information, or the latest or last uplink PDCP sequence number may also be carried to the UE. After receiving the indication, the network side will trigger the new configuration parameter of the network side to take effect, including establishing a new mapping relationship, generating a new downlink PDCP sequence number, and the like.

Optionally, the network side transmits indication information to the UE through the physical layer or the MAC layer or the RLC layer to notify the UE that the configuration has taken effect. The indication may be only one piece of indication information, or the latest or last downlink PDCP sequence number may also be carried to the UE.

Optionally, the new configuration parameter does not take effect immediately after being received by the UE. Instead, a time point manner is adopted. That is, when a specified time point is reached, the new configuration parameter is triggered to take effect, and the network side also triggers the new configuration parameter to take effect at this specified time point. The new PDCP sequence numbers are determined at the uplink and downlink.

As shown in FIG. 7, some embodiments of the present disclosure further provide a method for network entity handover, including:

step 71: transmitting, by a first network entity that is connected to a terminal to a second network entity that is connected to the terminal, indication information of an anchor change operation of changing an anchor from the first network entity to the second network entity;

step 72: receiving, by the first network entity, a new configuration parameter returned by the second network entity according to the indication information; and

step 73: transmitting, by the first network entity, the new configuration parameter to the terminal; specifically, the first network entity transmits the new configuration parameter to the terminal through radio resource control (RRC) message; and the new configuration parameter is used to enable the terminal to perform a new configuration according to the configuration parameter, and to switch an anchor to the second network entity after the new configuration is completed.

In this embodiment of the present disclosure, for a multi-connection UE, the master network entity (the first network entity) may select a certain one of the slave network entities (the second network entity) as the new anchor, thus triggering an anchor (referring to the master network entity) change operation; as such, a seamless transfer of service data can be ensured, thereby alleviating adverse effects on the system.

In this embodiment, based on the radio channel condition of the terminal, the load status of the network entity, the path delay between the terminal and the network entity, and/or RRM (Radio Resource Management) policies, the second network entity selects one of a plurality of network entities that are connected to the terminal.

The indication information at least includes new configuration information based on the second network entity, and the new configuration information include security context information based on the second network entity.

The indication information further includes: an effectiveness time point of the new configuration information, a radio configuration parameter based on the signaling bearer of the first network entity, and/or a PDCP (packet data convergence protocol) configuration parameter based on the data bearer of the first network entity.

The new configuration parameter includes: a new encryption algorithm based on the second network entity, a radio configuration parameter of a signaling bearer, a PDCP (packet data convergence protocol) parameter of a data bearer and/or a radio parameter of the bottom layer transmission used by updating the data bearer from the first network entity to the second network entity.

In this embodiment, the method may further include:

when the first network entity receives the sequence number of the new data packet notified by the second network entity, determining that the service data packet transmitted by the first network entity to the terminal before the sequence number have all been correctly received by the terminal, and that the service data packet transmitted by the terminal has been correctly received, and triggering the first network entity to release its configuration sublayer, and a connection relationship between the configuration sublayer and the bottom layer of the first network entity. As such, the processing burden on the network entity is lessened.

In this embodiment of the present disclosure, on the network side, an anchor change indication is initiated by the master network entity (the first network entity) to the target slave network entity (the second network entity), wherein at least the new security context information, or old radio configuration parameter or the like is included.

After the target receives the indication from the network entity, it selects a new encryption algorithm and configures a new radio parameter.

The target then returns a corresponding configuration parameter from the network entity to the master network entity, and the final RRC message is synthesized by the master network entity and transmitted to the UE.

Once the new configuration takes effect, none of network entities performs reestablishment or reset operations on the layer 2/physical layer. In the uplink direction, all PDCP PDUs first perform a header removing operation to determine whether it is new data and submit it to the correct target PDCP layer.

In the downlink direction, the RLC/MAC/PHY continues to maintain the original transmission activity; at the same time, it establishes a new mapping relationship with the new PDCP entity and allows processing of PDU data from the new PDCP entity.

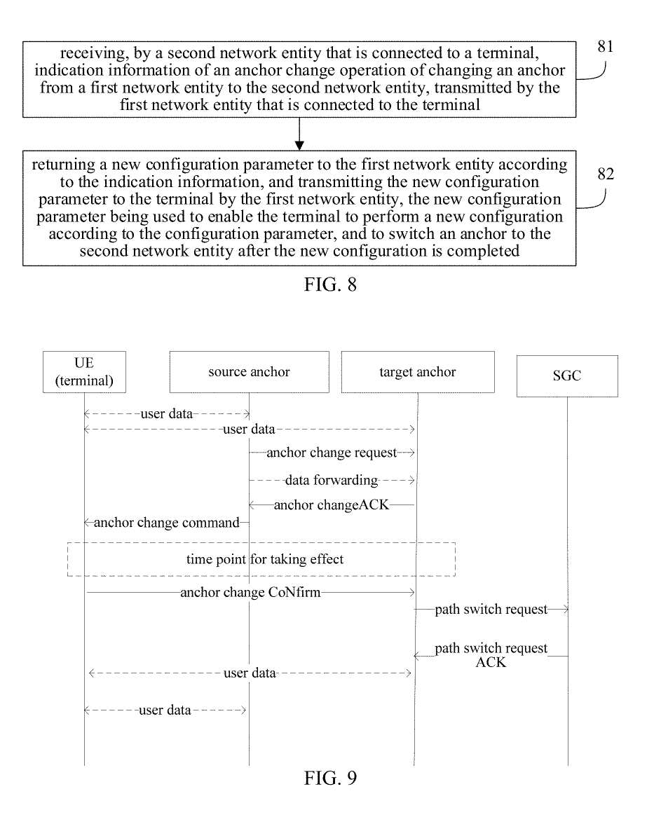

As shown in FIG. 8, some embodiments of the present disclosure provide a method for network entity handover, including:

step 81: receiving, by a second network entity that is connected to a terminal, indication information of an anchor change operation of changing an anchor from a first network entity to the second network entity, transmitted by the first network entity that is connected to the terminal; and

step 82: returning a new configuration parameter to the first network entity according to the indication information, and transmitting the new configuration parameter to the terminal by the first network entity, the new configuration parameter being used to enable the terminal to perform a new configuration according to the configuration parameter, and to switch an anchor to the second network entity after the new configuration is completed.

In this embodiment of the present disclosure, for a multi-connection UE, the master network entity (the first network entity) may select a certain one of the slave network entities (the second network entity) as the new anchor, thus triggering an anchor (referring to the master network entity) change operation; further, the new configuration parameter can be configured and transmitted to the terminal to enable the terminal to perform data transmission with the second network entity according to the new configuration parameter. As such, a seamless transfer of service data can be ensured, thereby alleviating adverse effects on the system.

In this embodiment, the handover method further includes:

step 83: receiving, by the second network entity, an anchor change confirmation message that is fed back after the terminal completes the configuration according to the new configuration parameter; and

step 84: switching the path from the first network entity to the second network entity according to the anchor change confirmation message or according to the new configuration parameter that has taken effect.

Specifically, a path switch request message is transmitted to a session gateway controller (SGC) according to the anchor change confirmation message or according to the new configuration parameter that has taken effect; and

a switch completion response message indicating that the path has been switched from the first network entity to the second network entity, returned by the session gateway controller (SGC), is received.

In this embodiment, the handover method may further include:

step 85: performing data transmission with the terminal.

Specifically, in the downlink direction, a new data packet transmitted to the terminal are transmitted to the terminal through a configuration sublayer of the second network entity.

Specifically, a new sequence number is added to the packet header of the data packet transmitted to the terminal, compressing, encrypting, and increasing of the packet header of the data packet are sequentially performed to obtain a new data packet, and the new data packet is transmitted to the terminal through a bottom layer according to routing information; wherein the packet header of the data packet carries indication information of new data transmitted to the terminal and included in the data packet.

Alternatively, in the uplink direction, the new data packet received from the terminal is processed by the configuration sublayer.

Specifically, a packet header is removed from the new data packet received from the terminal to obtain processed data packet; and

decrypting, re-ordering, and decompressing of the data packet are sequentially performed on the data packet, and then the data packet is transmitted to in-order delivery and duplicate detection functional entity for processing.

The new data packet includes: a new signaling data packet and/or a new service data packet.

In this embodiment of the present disclosure, a triggering condition for the new configuration parameter to take effect include:

when the triggering information transmitted by the terminal is received, an effectiveness triggering operation is performed on the new configuration parameter, wherein the triggering message is triggering information transmitted by the terminal after the new configuration parameter takes effect immediately after they are received; or

before the terminal transmits the indication information through the bottom layer, an effectiveness triggering operation is performed on the new configuration parameter, wherein the indication information is used to enable the terminal to perform an effectiveness triggering operation on the new configuration parameter; or

an effectiveness operation is triggered on the new configuration parameter at a preset time point, and the terminal performs an effectiveness triggering operation on the new configuration parameter at the preset time point.

Optionally, after the new configuration parameter takes effect, the second network entity does not perform reset and/or reestablishment of the bottom layer transmission.

The specific implementation scenarios of the foregoing embodiments are specifically described below, including implementation example 1, implementation example 2, and implementation example 3.

FIG. 9 is a schematic flowchart of implementation example 1 of the present disclosure. As shown in FIG. 9, the UE maintains wireless connection with two network entities, and the handover process includes steps 1 to 10.

Step 1: The original master network entity (the first network entity), based on the radio channel condition of the UE, the load status, the path delay, or other RRM (Radio Resource Management) policies, selects a certain one of the slave network entities (the second network entity) as the new master network entity, and triggers an anchor (referring to the master network entity) change operation;

Step 2: The original master network entity initiates an anchor change indication to the target slave network entity, wherein at least the new security context information (such as a new Key eNodeB Star and Next Hop Chaining Count and similar parameters) or an effectiveness time point of new configuration is included. In addition, all the radio configuration parameters of the old signaling bearer, or the PDCP configuration parameter of the old data bearer may be included;

Step 3: After the target network entity receives the indication, it saves the new configuration parameter, selects a new encryption algorithm, configures all the radio parameters of the new signaling bearer, and/or configures PDCP parameter of the new data bearer, or updates radio parameter such as RLC/MAC/PHY of this data bearer at the slave network entity part. Then, the target slave network entity returns the corresponding configuration parameter to the master network entity;

Step 4: The final RRC message is synthesized by the original master network entity and transmitted to the UE.

The parameter includes at least the new security context (such as security parameter required for the UE to generate a new security key and/or a newly selected encryption algorithm, etc.). Moreover, the network side may indicate the effectiveness time point of the new configuration;

Step 5: When the specified time point is reached, the UE triggers the new configuration to take effect, and transmits an anchor change confirmation message to the network side; at the same time, the network side also triggers the new configuration parameter to take effect at the specified time point;

Step 6: Once the new configuration takes effect, the UE does not perform layer 2/physical layer reestablishment and reset operations, and there are two sets of PDCP sub-configurations for each DRB and/or SRB.

The two sets of PDCP sub-configurations as a whole remain connected to the original two or more layers 2/physical layers.

For example, in the downlink direction, a header removing operation is performed on the PDCP PDU which receives any RLC. If the PDU header contains a new data indication, the PDU is delivered to the new configuration sublayer, sequentially decrypted, re-ordered, decompressed, and then submitted to in-order delivery and duplicate detection functional entity;

If the PDU header does not contain a new data indication, the PDU is delivered to the old configuration sublayer, similar operations are performed in sequence, and finally the PDU is also submitted to the in-order delivery and duplicate detection functional entity.

In the uplink direction, all RLC/MAC/PHY continue to maintain the original transmission activity.

At the same time, the new PDCP SDU will be assigned a new SN and delivered to the new configuration sublayer, sequentially compressed, encrypted, and added by a PDU header. The header will contain new data indication, and then the data will be passed to an appropriate RLC/MAC/PHY connection for data transmission, according to the routing information.

Step 7: The target slave network entity, after receiving the RRC reconfiguration completion message from the UE (i.e., the anchor change confirmation message), or after the new configuration takes effect, performs a path switch operation, and the specific operation is similar to the traditional path switch operation after X2 switch.

Step 8: Once the new configuration takes effect, none of network entities performs an L2 reset operation.

For example, for the new master network entity, in the downlink direction, the RLC/MAC/PHY continues to maintain the original transmission activity; at the same time, the new PDCP entity establishes a new mapping relationship with the RLC/MAC/PHY, and the generated new PDCP PDU is submitted to the bottom layer (RLC) for new data transmission activities, wherein each new PDU header carries an indication of new data packet.

In the uplink direction, a header removing operation is performed on the PDCP PDU which receives any RLC (such as from a local RLC or from a new slave network PDU). If the PDU header contains a new data indication, the PDU is delivered to the new PDCP entity, sequentially decrypted, re-ordered, decompressed, and then submitted to the local in-order delivery and duplicate detection functional entity;

If the PDU header does not contain a new data indication, the PDU is transmitted to the PDCP layer of the old master network entity through the interface, similar operations are performed in sequence, and finally the PDU is submitted to the local in-order delivery and duplicate detection functional entity.

For the new slave network entity, in the downlink direction, the RLC/MAC/PHY continues to maintain the original transmission activity; at the same time, it establishes a new mapping relationship with the PDCP layer of the new master network entity and allows receiving PDCP PDU from the new master network entity.

In the uplink direction, any PDCP PDU from the local RLC needs to be de-headed. If the PDU header does not contain a new data indication, the PDU is submitted to the local old PDCP entity, sequentially decrypted, re-ordered, decompressed, and then submitted to the local in-order delivery and duplicate detection functional entity. If the PDU header contains a new data indication, the PDU is delivered to the new PDCP entity through the interface, similar operations are performed in sequence, and finally the PDU is submitted to the local in-order delivery and duplicate detection functional entity.

Step 9: On the UE side, the PDCP entity determines that all the downlink PDUs before the new data sequence number have been correctly received. At the same time, it is determined that all the uplink PDUs before the new data sequence number have been confirmed, and a release operation of the old PDCP configuration sublayer is triggered.

Step 10: Similarly, on the network side, in the downlink direction, the new PDCP entity needs to notify the old PDCP entity of the start value of the new data sequence number of the downlink PDU, and the old PDCP entity is responsible for determining whether all the old downlink PDUs have been confirmed. At the same time, in the uplink direction, after receiving the new uplink PDU, the new PDCP entity notifies the old PDCP entity of the start value of the new data sequence number, and the old PDCP entity is responsible for determining whether all the old uplink PDUs have been correctly received. The old master network entity will then trigger a release operation of the old PDCP entity, and at the same time, the connection relationship of the old PDCP layer with each RLC/MAC/PHY is released.

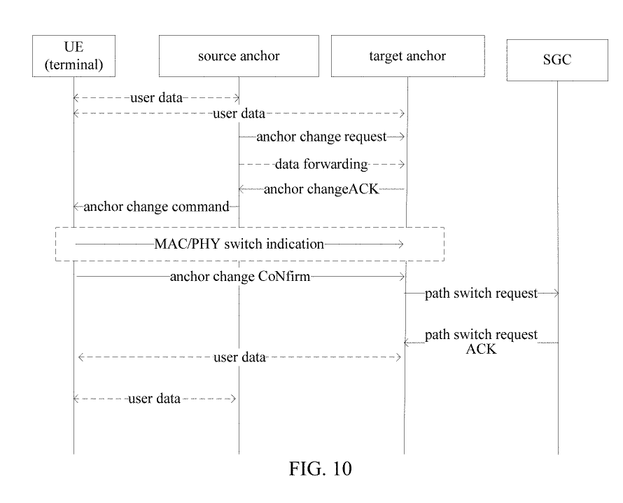

FIG. 10 is a schematic flowchart of implementation example 2 of the present disclosure. As shown in FIG. 10, the UE maintains wireless connection with two network entities, and the handover process includes steps 1 to 10.

Step 1: The same as step 1 of embodiment 1;

Step 2: The original master network entity initiates an anchor change indication to the target slave network entity, wherein at least the new security context information (such as a new Key eNodeB Star and Next Hop Chaining Count and similar parameters) is included. In addition, all the radio configuration parameters of the old signaling bearer, or the PDCP configuration parameter of the old data bearer may be included;

Step 3: The same as step 3 of embodiment 1;

Step 4: The final RRC message is synthesized by the original master network entity and transmitted to the UE. The parameter includes at least the new security context (such as security parameter required for the UE to generate a new security key and/or a newly selected encryption algorithm, etc.);

Step 5: After being received by the UD, the configuration takes effect immediately. The UE transmits a message to notify the network, and then transmits an anchor change confirmation message to the network side. The trigger information is only one indication signaling, and may also carry the latest or last uplink PDCP sequence number to the network side;

Step 6: The same as step 6 of embodiment 1;

Step 7: The target slave network entity, after receiving the indication information from the UE, enters a new configuration effectiveness status, or after the new configuration takes effect, performs a path switch operation, and the specific operation is similar to the traditional path switch operation after X2 switch.

Steps 8 to 10: The same as steps 8 to 10 of embodiment 1.

In implementation example 3:

the UE maintains a wireless connection with two network entities, and the handover process includes steps 1 to 10.

Step 1: The same as step 1 of embodiment 1;

Step 2: The original master network entity initiates an anchor change indication to the target slave network entity, wherein at least the new security context information (such as a new Key eNodeB Star and Next Hop Chaining Count and similar parameters) is included. In addition, all the radio configuration parameters of the old signaling bearer, or the PDCP configuration parameter of the old data bearer may be included;

Step 3: The same as step 3 of embodiment 1;

Step 4: The final RRC message is synthesized by the original master network entity and transmitted to the UE. The parameter includes at least the new security context (such as security parameter required for the UE to generate a new security key and/or a newly selected encryption algorithm, etc.);

Step 5: After receiving the new configuration, the UE triggers the new configuration to take effect when receiving the indication information transmitted by the network side, whereas the network side triggers the new configuration parameter to take effect before transmitting the indication information, and then transmits an anchor change confirmation message to the network side.

Step 6: The same as step 6 of embodiment 1;

Step 7: The target slave network entity, after receiving the indication information from the UE, enters a new configuration effectiveness status, or after the new configuration takes effect, performs a path switch operation, and the specific operation is similar to the traditional path switch operation after X2 switch.

Steps 8 to 10: The same as steps 8 to 10 of embodiment 1.

In the foregoing embodiments of the present disclosure, for a multi-connection UE, the master network entity may select a certain one of slave network entities as a new anchor, triggering an anchor (referring to the master network entity) change operation. Specifically, at least one of the following two operations is performed, or the two operations are performed simultaneously: i) transferring PDCP entities of all the bearers from the master network entity to the target slave network entity, and performing the reestablishment operation; and ii) changing the signaling termination point and/or data path to the core network (from the master network entity to the target slave network entity). In addition, functional entities (such as RLC/MAC/physical layer and similar functional entities) other than the PDCP entity remain unchanged; the service data can be seamlessly transferred, thereby alleviating the adverse effects on the system.

The original master network entity initiates an anchor change indication to the target slave network entity, wherein at least the new security context information (such as a new Key eNodeB Star and Next Hop Chaining Count and similar parameters) or an effectiveness time point of new configuration is included. In addition, all the radio configuration parameters of the old signaling bearer, or the PDCP configuration parameter of the old data bearer may be included.

After the target network entity receives the indication, it saves the new configuration parameter, selects a new encryption algorithm, configures all the radio parameters of the new signaling bearer, and/or configures PDCP parameter of the new data bearer, or updates radio parameter such as RLC/MAC/PHY of this data bearer at the slave network entity part. Then, the target slave network entity returns the corresponding configuration parameter to the master network entity.

The final RRC message is synthesized by the original master network entity and transmitted to the UE. The parameter includes at least the new security context (such as security parameter required for the UE to generate a new security key and/or a newly selected encryption algorithm, etc.). Moreover, the network side may indicate the effectiveness time point of the new configuration.

Once the new configuration takes effect, the UE does not perform layer 2/physical layer reestablishment and reset operations, and there are two sets of PDCP sub-configurations for each DRB and/or SRB. The two sets of PDCP sub-configurations as a whole remain connected to the original two or more layers 2/physical layers. For example, in the downlink direction, a header removing operation is performed on the PDCP PDU which receives any RLC. If the PDU header contains a new data indication, the PDU is delivered to the new configuration sublayer, sequentially decrypted, re-ordered, decompressed, and then submitted to in-order delivery and duplicate detection functional entity; if the PDU header does not contain a new data indication, the PDU is delivered to the old configuration sublayer, similar operations are performed in sequence, and finally the PDU is also submitted to the in-order delivery and duplicate detection functional entity. In the uplink direction, all RLC/MAC/PHY continue to maintain the original transmission activity; at the same time, the new PDCP SDU will be assigned a new SN and delivered to the new configuration sublayer, sequentially compressed, encrypted, and added by a PDU header. The header will contain new data indication, and then the data will be passed to an appropriate RLC/MAC/PHY connection for data transmission, according to the routing information.

The target slave network entity, after receiving the RRC reconfiguration completion message from the UE (i.e., the anchor change confirmation message), or after the new configuration takes effect, performs a path switch operation, and the specific operation is similar to the traditional path switch operation after X2 switch.

Once the new configuration takes effect, none of network entities performs an L2 reset operation. For example, for the new master network entity, in the downlink direction, the RLC/MAC/PHY continues to maintain the original transmission activity; at the same time, the new PDCP entity establishes a new mapping relationship with the RLC/MAC/PHY, and the generated new PDCP PDU is submitted to the bottom layer (RLC) for new data transmission activities, wherein each new PDU header carries an indication of new data packet. In the uplink direction, a header removing operation is performed on the PDCP PDU which receives any RLC (such as from a local RLC or from a new slave network PDU). If the PDU header contains a new data indication, the PDU is delivered to the new PDCP entity, sequentially decrypted, re-ordered, decompressed, and then submitted to the local in-order delivery and duplicate detection functional entity; if the PDU header does not contain a new data indication, the PDU is transmitted to the PDCP layer of the old master network entity through the interface, similar operations are performed in sequence, and finally the PDU is submitted to the local in-order delivery and duplicate detection functional entity. For the new slave network entity, in the downlink direction, the RLC/MAC/PHY continues to maintain the original transmission activity; at the same time, it establishes a new mapping relationship with the PDCP layer of the new master network entity and allows receiving PDCP PDU from the new master network entity. In the uplink direction, any PDCP PDU from the local RLC needs to be de-headed. If the PDU header does not contain a new data indication, the PDU is submitted to the local old PDCP entity, sequentially decrypted, re-ordered, decompressed, and then submitted to the local in-order delivery and duplicate detection functional entity. If the PDU header contains a new data indication, the PDU is delivered to the new PDCP entity through the interface, similar operations are performed in sequence, and finally the PDU is submitted to the local in-order delivery and duplicate detection functional entity.

On the UE side, the PDCP entity determines that all the downlink PDUs before the new data sequence number have been correctly received. At the same time, it is determined that all the uplink PDUs before the new data sequence number have been confirmed, and a release operation of the old PDCP configuration sublayer is triggered.

On the network side, in the downlink direction, the new PDCP entity needs to notify the old PDCP entity of the start value of the new data sequence number of the downlink PDU, and the old PDCP entity is responsible for determining whether all the old downlink PDUs have been confirmed. At the same time, in the uplink direction, after receiving the new uplink PDU, the new PDCP entity notifies the old PDCP entity of the start value of the new data sequence number, and the old PDCP entity is responsible for determining whether all the old uplink PDUs have been correctly received. The old master network entity will then trigger a release operation of the old PDCP entity, and at the same time, the connection relationship of the old PDCP layer with each RLC/MAC/PHY is released.

After being received by the UD, the configuration takes effect immediately. The UE transmits a message to notify the network, and then transmits an anchor change confirmation message to the network side. The trigger information is only one indication signaling, and may also carry the latest or last uplink PDCP sequence number to the network side; or the network side may notify the UE that the configuration has taken effect through the physical layer or the MAC layer or the RLC layer indication information, which may specifically be only one piece of indication information, and may also carry the latest or last uplink PDCP sequence number to the UE. Alternatively, after the UE receives the new configuration, the new configuration does not take effect immediately. The new configuration takes effect at the specified time.

Some embodiments of the present disclosure further provide a terminal, including:

a receiver configured to execute the following function: receiving a new configuration parameter of a second network entity that is connected to the terminal, transmitted by a first network entity that is connected to the terminal, wherein the new configuration parameter is configured by the second network entity according to indication information of an anchor change operation of changing an anchor from the first network entity to the second network entity, transmitted by the first network entity; and

a transmitter configured to execute the following functions: not performing reset and/or reestablishment of the bottom layer transmission after the new configuration parameter takes effect; and transmitting an anchor change confirmation message to the second network entity.

It should be noted that the embodiment of the terminal is a device or apparatus corresponding to the methods in the foregoing embodiments, and all the implementation manners in the foregoing embodiments are applicable to the embodiment of the terminal, while also achieving the same technical effect.

Some embodiments of the present disclosure further provide a network entity device, including:

a transmitter configured to execute the following function: transmitting indication information of an anchor change operation of changing an anchor from a first network entity to a second network entity, to the second network entity that is connected to the terminal; and

a receiver configured to execute the following function: receiving new configuration parameter returned by the second network entity according to the indication information;

wherein the transmitter is further configured to transmit the new configuration parameter to the terminal, the new configuration parameter being used to enable the terminal to perform a new configuration according to the configuration parameter, and to switch an anchor to the second network entity after the new configuration is completed.

It should be noted that the network entity device is a device or apparatus corresponding to the method of the first network entity device side in the foregoing embodiments, and all the implementation manners in the foregoing embodiments are applicable to the embodiment of the device, while also achieving the same technical effect.

Some embodiments of the present disclosure further provide a network entity device, including:

a receiver configured to execute the following function: receiving indication information of an anchor change operation of changing an anchor from a first network entity to a second network entity, transmitted by the first network entity that is connected to the terminal; and

a transmitter configured to execute the following functions: returning new configuration parameter to the first network entity according to the indication information, and transmitting the new configuration parameter to the terminal by the first network entity, the new configuration parameter being used to enable the terminal to perform a new configuration according to the new configuration parameter, and to switch an anchor to the second network entity after the new configuration is completed.

It should be noted that the network entity device is a device or apparatus corresponding to the method of the second network entity device side in the foregoing embodiments, and all the implementation manners in the foregoing embodiments are applicable to the embodiment of the device, while also achieving the same technical effect.

It will be appreciated by those skilled in the art that the elements and algorithm steps of the various examples described in connection with the embodiments disclosed herein can be implemented in electronic hardware or in a combination of computer software and electronic hardware. Whether these functions are executed in hardware or software depends on the specific application and design constraints of the technical solution. A person skilled in the art can use different methods to implement the described functions for each particular application, but such implementation should not be considered to be beyond the scope of the present disclosure.

Those skilled in the art can clearly understand that for the convenience and brevity of the description, for the specific operational process of the system, the device and the units described above, reference may be made to the corresponding process in the foregoing method embodiments, and no repeated description is given herein.

In the several embodiments provided by the present disclosure, it should be understood that the disclosed device and method may be implemented in other manners. For example, the device embodiments described above are merely illustrative. For example, the division of the units is only a division in terms of logical function. In actual implementation, there may also be other division manners; for example, multiple units or components may be combined or integrated into another system, or some features can be omitted or not executed. In addition, the mutual coupling or direct coupling or communication connection as shown or discussed may be an indirect coupling or communication connection through some interfaces, devices or units, and may be in electrical, mechanical or other forms.

The units described as separate components may be or may not be physically separated, and the components displayed as units may be or may not be physical units, that is, they may be located in one place, or may be distributed over multiple network units. Some or all of the units may be selected according to actual requirements to achieve the purpose of the solution of the embodiment.

In addition, individual functional units in various embodiments of the present disclosure may be integrated into one processing unit, or individual units may be physically included separately, or two or more units may be integrated into one unit.

If implemented in the form of software functional units and sold or used as a stand-alone product, the functions may be stored in a computer readable storage medium. Based on such understanding, the essential part of the technical solution of the present disclosure, or the part or the part of the technical solution which contributes to the related art, may be embodied in the form of a software product. The software product is stored in a storage medium which includes a plurality of instructions for causing a computer device (which may be a personal computer, a server, or a network device, etc.) to execute all or part of the steps of the methods of the various embodiments of the present disclosure. The foregoing storage medium includes: a U disk, a mobile hard disk, a Read-Only Memory (ROM), a Random Access Memory (RAM), a magnetic disk or an optical disk, and various media that can store program codes thereon.

In addition, it should be noted that in the device and method of the present disclosure, it is apparent that the various components or steps may be decomposed and/or recombined. These decompositions and/or recombinations should be considered as equivalent solutions of the present disclosure. Also, the steps of performing the above-described series of processes may naturally be performed in a chronological order as illustrated, but it is not necessary that they be performed in chronological order, and some steps may be performed in parallel or independently from each other. It will be appreciated by those skilled in the art that all or any of the steps or components of the method and device of the present disclosure may be in a network of any computing device (including a processor, a storage medium, etc.) or a computing device, and implemented in hardware, firmware, software, or a combination thereof, which can be realized by those skilled in the art using their basic programming skills upon reading the teachings of the present disclosure.

Accordingly, the objects of the present disclosure can also be implemented by running a program or a set of programs on any computing device. The computing device can be a well-known general purpose device. Accordingly, the objects of the present disclosure may also be realized by merely providing a program product including program codes for implementing the method or device. That is, such a program product also constitutes the present disclosure, and a storage medium storing such a program product also constitutes the present disclosure. It will be apparent that the storage medium may be any known storage medium or any storage medium to be developed in the future. It should also be noted that in the device and method of the present disclosure, it is apparent that the various components or steps may be decomposed and/or recombined. These decompositions and/or recombinations should be considered as equivalent solutions of the present disclosure. Also, the steps of performing the above-described series of processes may naturally be performed in a chronological order as illustrated, but it is not necessary that they be performed in chronological order, and some steps may be performed in parallel or independently from each other.

Described above are preferred embodiments of the present disclosure, and it should be noted that those skilled in the art can also make several improvements and modifications without departing from the principles of the present disclosure, which will also fall within the scope of protection of the present disclosure.

1. A method for network entity handover, comprising:
receiving a new configuration parameter of a second network entity that is connected to a terminal, the new configuration parameter being transmitted by a first network entity that is connected to the terminal, the new configuration parameter being configured by the second network entity according to indication information of an anchor change operation of changing an anchor from the first network entity to the second network entity, and the indication information being transmitted by the first network entity; and
when the new configuration parameter takes effect, not performing reset and/or reestablishment of bottom layer transmission, and transmitting an anchor change confirmation message to the second network entity.

2. The method according to claim 1, wherein after the anchor change confirmation message is transmitted to the second network entity, the method further comprises:
after the second network entity switches a path from the first network entity to the second network entity according to the anchor change confirmation message, performing data transmission with the second network entity.

3. The method according to claim 2, wherein the step of performing data transmission with the second network entity comprises:
transmitting, through a first configuration sublayer, a new data packet to be transmitted to the second network entity, to the second network entity; or
processing, through the first configuration sublayer, the new data packet received from the second network entity.

4. The method according to claim 3, wherein the step of transmitting through the first configuration sublayer the new data packet to be transmitted to the second network entity to the second network entity comprises:
adding a new sequence number to a packet header of the data packet to be transmitted to the second network entity, and sequentially compressing, encrypting, and increasing the packet header of the data packet to obtain the new data packet; and
transmitting the new data packet to the second network entity through a bottom layer according to routing information.

5. The method according to claim 4, wherein the packet header of the data packet carries indication information of new data transmitted to the second network entity and comprised in the data packet.

6. The method according to claim 3, wherein the step of processing through the first configuration sublayer the new data packet received from the second network entity comprises:
removing a packet header from the new data packet received from the second network entity to obtain a processed data packet; and
sequentially decrypting, re-ordering, and decompressing the data packet, and then transmitting the data packet to an in-order delivery and duplicate detection functional entity for processing.

7. The method according to claim 6, wherein the step of sequentially decrypting, re-ordering, and decompressing the data packet, and then transmitting the data packet to the in-order delivery and duplicate detection functional entity for processing comprises:
decrypting the data packet and transmitting the data packet to a re-ordering entity, forwarding the re-ordered new data packet to a decompressing entity of the first configuration sublayer for decompression operation, according to header information, and then transmitting the data packet to the in-order delivery and duplicate detection functional entity for processing; or
decrypting the data packet, transmitting the data packet to a re-ordering entity and a decompressing entity for corresponding processing, and then transmitting the data packet to the in-order delivery and duplicate detection functional entity for processing.

8. The method according to claim 3, wherein the new data packet comprises: a new signaling data packet and/or a new service data packet.

9. The method according to claim 3, wherein after the second network entity switches the path from the first network entity to the second network entity according to the anchor change confirmation message, the method further comprises:
performing transmission of service data packet with the first network entity.

10. The method according to claim 9, wherein the step of performing transmission of the service data packet with the first network entity comprises:
transmitting, through a second configuration sublayer, the service data packet to be transmitted to the first network entity to the bottom layer, and transmitting the service data packet to the first network entity; or
transmitting, through the bottom layer, the service data packet received from the first network entity to the second configuration sublayer for processing.

11. The method according to claim 10, wherein the step of transmitting through the second configuration sublayer the service data packet to be transmitted to the first network entity to the bottom layer, and transmitting the service data packet to the first network entity comprises:
after the service data packet to be transmitted to the first network entity is sequentially compressed and encrypted, transmitting the service data packet to the first network entity through the bottom layer according to routing information.

12. The method according to claim 10, wherein the step of transmitting through the bottom layer the service data packet received from the first network entity to the second configuration sublayer for processing comprises:
sequentially decrypting, re-ordering, and decompressing the service data packet received from the first network entity through the bottom layer, and then transmitting the data packet to an in-order delivery and duplicate detection functional entity for processing.

13. The method according to claim 9, further comprising:
when the terminal has received correctly the data packet from the first network entity before a sequence number of the data packet of the second network entity, and the terminal has received a confirmation message that the first network entity has received uplink data packets transmitted by all of the terminals before the sequence number, triggering a release operation of the second configuration sublayer.

14. The method according to claim 1, wherein a triggering condition for the new configuration parameter to take effect comprises:
when the terminal receives the new configuration parameter, the new configuration parameter immediately takes effect, and the terminal transmits triggering information to notify the second network entity, to enable the second network entity to perform an effectiveness triggering operation on the new configuration parameter; or
when the terminal receives the indication information transmitted by the second network entity through the bottom layer, the terminal performs an effectiveness triggering operation on the new configuration parameter, and when the second network entity transmits the indication information, the second network entity performs an effectiveness triggering operation on the new configuration parameter; or
after the terminal receives the new configuration parameter, the terminal triggers an effectiveness operation on the new configuration parameter at a preset time point, and the second network entity performs an effectiveness triggering operation on the new configuration parameter at the preset time point.

15. The method according to claim 14, wherein the triggering information carries a sequence number of a new data packet transmitted to the second network entity; and
the indication information carries the sequence number of the new data packet transmitted by the second network entity to the User Equipment (UE).

16. A method for network entity handover, comprising:
transmitting, by a first network entity that is connected to a terminal to a second network entity that is connected to the terminal, indication information of an anchor change operation of changing an anchor from the first network entity to the second network entity;
receiving, by the first network entity, a new configuration parameter returned by the second network entity according to the indication information; and
transmitting, by the first network entity, the new configuration parameter to the terminal, the new configuration parameter being used to enable the terminal to perform a new configuration according to the configuration parameter, and to switch the anchor to the second network entity after the new configuration is completed.

17-22. (canceled)

23. A method for network entity handover, comprising:
receiving, by a second network entity that is connected to a terminal, indication information of an anchor change operation of changing an anchor from a first network entity to the second network entity, and the indication information being transmitted by the first network entity that is connected to the terminal; and
returning a new configuration parameter to the first network entity according to the indication information, and transmitting the new configuration parameter to the terminal by the first network entity, the new configuration parameter being used to enable the terminal to perform a new configuration according to the new configuration parameter, and to switch the anchor to the second network entity after the new configuration is completed.

24-33. (canceled)

34. A terminal, comprising: a memory, a processor, and a computer program stored in the memory and configured to be executed by the processor, wherein the processor is configured to execute the computer program to implement the method according to claim 1.

35. A network entity device, comprising: a memory, a processor, and a computer program stored in the memory and configured to be executed by the processor, wherein the processor is configured to execute the computer program to implement the method according to claim 16.

36. A network entity device, comprising: a memory, a processor, and a computer program stored in the memory and configured to be executed by the processor, wherein the processor is configured to execute the computer program to implement the method according to claim 23.
